(19) United States
(12) Patent Application Publication
(10) Pub. No.: US 2010/0119731 A1
(43) Pub. Date: May 13, 2010

(54) APPARATUS AND METHOD FOR UV IRRADIATION OF ONE OR MORE RADIATION-CURABLE COATINGS

(76) Inventor: Charles Maria Hubertus Johannes Van Kan, Geleen (NL)

Correspondence Address: ROBERTS & ROBERTS, LLP;ATTORNEYS AT LAW, P.O. BOX 484, PRINCETON, NJ, 08542-0484, US

(21) Appl. No.: 12/597,392

(22) PCT Filed: Apr. 25, 2008
(86) PCT No.: PCT/NL2008/000112

§ 371 Date: Dec. 3, 2009

(30) Foreign Application Priority Data
Apr. 25, 2007 (NL) 1033751

(51) Int. Cl. B05D 3/06; B05C 9/12

(52) U.S. Cl. 427/553; 118/620

(57) ABSTRACT

The present invention relates to an apparatus for UV irradiation of one or more radiation-curable coatings, which coatings have been applied to a substrate, which apparatus comprises a radiation unit for irradiating said one or more radiation-curable coatings present on the substrate, which substrate is passed under the radiation unit, wherein the apparatus further comprises a shutter element, which shutter element is positioned between the substrate and the radiation unit, and which comprises at least one plate, which plate is movable over some distance in the plane substantially parallel to the substrate for defining the area over which said one or more radiation-curable coatings present on the substrate will be irradiated by the radiation unit.

The present invention relates to an apparatus and a method for UV irradiation of one or more radiation-curable coatings, which coatings have been applied to a substrate, which apparatus comprises a radiation unit for irradiating said one or more radiation-curable coatings present on the substrate, which substrate is passed under the radiation unit.

From European patent application No. 0 706 834 a process is known for the production of a substrate material provided with a UV curable coating consisting of a lacquer with a base of an acrylate mixture, a UV initiator and other usual additives. The matting degree of the aforesaid UV varnish is adjusted by the addition of mono- and/or difunctional monomers, and UV hardening is effected with several radiation sources with a defined range of wavelengths' Thus a first UV source is used, which emits monochromatic UV light having a wavelength of 100-200 nm, after which the coating thus applied to the substrate layer is irradiated with UV light a second time, using radiation having a higher wavelength.

From German Offenlegungsschrift DE 198 42 510 there is known a process for structuring the surface of a UV curable lacquer by irradiation with UV light having a wavelength of maximally 250 nm. Instead of using irradiation with UV light, curing could also take place by means of electron beam irradiation. As an example of a UV curable lacquer, a mixture of monomers and prepolymers of acrylate components is mentioned, with paper or plastic in a thickness of 80-500 μm being used as the substrate material. No further information regarding process settings and the equipment suitable for that purpose is provided therein.

From German Patentschrift No. 199 33 960 it is known to arrange three light sources 18a, 18b and 18c parallel to each other at an angle to the conveying direction.

From U.S. Pat. No. 5,300,331 an apparatus for irradiating UV curable coatings is known, which document mentions wood and MDF as examples of substrate materials.

From European patent application No. 0 558 114 there is known an apparatus for applying a coating to a circuit board in which two pairs of UV lamps are used for curing a circuit board, in particular the coating present thereon.

US patent application US 2001/0 018 893, discloses a curing chamber in which two radiation sources are arranged.

The present inventors have done intensive research into the matting of UV curable coatings, in which connection it is desirable that the dose of the UV radiation, in particular shortwave UV radiation, be uniformly distributed both across the width and the length of the substrate, so that every part of the substrate surface will receive a substantially constant and identical amount of radiation. Such uniformity is in particular important when a change in the conveying velocity of the substrate occurs because the substrate is being passed under the UV radiation source(s). In this latter situation it is desirable, therefore, that the irradiation with UV light be carried out in such a manner with varying production rates, viz. varying throughput speeds of the substrate, that the substrate is exposed to the same photon dose. In connection with the technical life of the UV radiation source it is undesirable to dim said UV radiation source over a wide range, taking into consideration the conveying velocity of the substrate under the radiation source(s).

Moreover, the present inventors' aim is to provide an apparatus for matting radiation-curable coatings in which a substrate material having a large width, in particular a width of up to maximally 6 metres, can be used, using throughput speeds of the substrate ranging from minimally 40 metres per minute to maximally 400 metres per minute.

The present inventors have furthermore found that the UV radiation sources which are currently commercially available are so short that, given the aforesaid dimensions of the substrate and the high production rates, such a radiation source is not suitable for matting and/or structuring the coating(s) present on the substrate in an advantageous manner.

The present inventors' aim is thus to provide an apparatus which solves the aforesaid problems or at least significantly reduces said problems.

The invention as referred to in the introduction is characterised in that the apparatus further comprises a shutter element, which shutter element is positioned between the substrate and the radiation unit, and which comprises at least one plate, which plate is movable over some distance in the plane substantially parallel to the substrate for defining the area over which said one or more radiation-curable coatings present on the substrate will be irradiated by the radiation unit.

One or more of the above objects are accomplished by using such a shutter element. The present inventors have in particular found that such a shutter element, which is placed in the light path between the radiation unit and the substrate positioned thereunder, makes it possible to expose said one or more radiation-curable coatings present on the substrate to a substantially uniform dose of UV light from the radiation unit across the width of the substrate. In addition to that, when such an apparatus is used it is possible to control the amount of UV light, which is influenced inter alia by the thickness and the composition of said one or more radiation-curable coatings present on the substrate. The present inventors have furthermore found that if two radiation sources are placed perpendicular to the conveying direction of the substrate, the final product, viz. the substrate provided with a matted UV curable coating, will exhibit stripe-shaped gloss differences, which stripe-shaped gloss differences can be attributed to a non-uniform UV dose on the surface, and as a consequence thereof non-uniform cross-linking of the UV curable coatings, which is undesirable. The position of the stripe-shaped gloss differences is determined by the location where the radiation dose is different.

In a special embodiment, it is furthermore preferable if the radiation unit comprises at least two separated radiation sources, which are each disposed in such a manner relative to the conveying direction of the substrate that said one or more radiation-curable coatings present on the substrate will be exposed to a substantially uniform dose of UV light from the radiation sources across the width of the substrate.

The present inventors have surprisingly found that at least one of the radiation sources, preferably at least two separated radiation sources, must be disposed in such a manner relative to the conveying direction of the substrate that the angle relative to the conveying direction of the substrate must range between 0° and 90°. Furthermore it is preferable that, in the embodiment comprising at least two separated radiation sources, each of said radiation sources is disposed at an angle of 20-70°, i.e. relative to the conveying direction of the substrate. The at least two separated radiation sources are preferably positioned parallel to each other. The length of the radiation source is furthermore preferably less than the width of the substrate.

The present invention is in particular suitable for use with a substrate having a width of maximally 6000 mm, preferably between 1200 and 2600 mm, whilst rates of transport of 40-400 m/minute, in particular 60-200 m/minute, are possible. The total radiation dose required for matting can preferably be controlled within a range of 1-3000 mJ/m², in particular within the range of 1-30 mJ/m², more in particular within the range of 3-12 mJ/m². It has been found that when a dose in the aforesaid range and the aforesaid conveying velocity is used, it is possible to obtain a substrate provided with one or more coatings whose coating has a degree of gloss or structuring of 4-12 points, measured with a 60 degrees measuring geometry.

The present inventors have furthermore found that the radiation time, viz. the time during which said one or more radiation-curable coatings are exposed to UV radiation, ranges from 50-800 ms, whilst the period of time between irradiation and fixation of the UV curable layer ranges between 1 and 15 seconds.

The spacing in vertical direction between said one or more radiation sources and a substrate provided with one or more radiation-curable coatings which is positioned thereunder is preferably 10-100 mm, in particular 20-40 mm. When said spacing is less than 10 mm, the coating may come into contact with the radiation source, as a result of which the radiation source will lose some of its functionality. On the other hand, if said distance is more than 100 mm, the radiation intensity will be insufficient, as a result of which the desired structuring of the coating(s) will not take place. It is also possible to flush the air gap between the substrate and the radiation sources with an inert gas, such as nitrogen or carbon dioxide, so as to positively affect the cross-linking of the coating.

A suitable radiation source emits light in the wavelength range of 100-450 nm, preferably in the wavelength range of 100-250 nm, in particular in the wavelength range of 170-180 nm. A particularly suitable radiation source is a radiation source which emits monochromatic radiation having a wavelength of 172 nm. In addition to that it is desirable in specific embodiments that said two or more radiation sources emit monochromatic radiation having a wavelength of 222 nm.

In the present apparatus at least two separate radiation units may be provided in the conveying direction of the substrate, each unit being provided with at least two separated radiation sources, said radiation sources being disposed in such a manner relative to the conveying direction of the substrate that said one or more radiation-curable coatings present on the substrate will be exposed to a substantially uniform dose of UV light from the radiation sources in question across the width of the substrate. The moving substrate is not exposed to radiation for a specific period of time, referred to as “dark cure time”, between the radiation units, which may have an advantageous effect on the cross-linking reaction. In this way it has been found to be possible to give the first radiation unit a wavelength different from that of the second radiation unit, whilst in addition also the radiation intensity, the duration of the radiation, the distance between the radiation source and the substrate can be varied according to the respective requirements.

The radiation sources used in the present apparatus have a diameter ranging between 20 and 60 mm, preferably they are spaced 30-90 mm apart.

From the viewpoint of life span and stability of the radiation source in the present apparatus it is desirable to keep the current intensity substantially constant, preferably between 4 and 6 amperes.

The shutter element in the present apparatus is preferably connected to a control circuit, in which case the movement of said at least one plate is controlled on the basis of the conveying velocity of the substrate under the radiation unit, whilst it is furthermore preferable to use the conveying velocity of the substrate under the radiation unit for dimming the radiation unit. This enables a precise adjustment and control of the desired radiation dose and radiation time.

The present application further relates to a method for UV irradiation of one or more radiation-curable coatings, which coatings have been applied to a substrate, as defined in more detail in the appended claims.

The present application further relates to a substrate provided with one or more radiation-curable coatings, wherein the radiation dose received by the coating(s) exhibits a variation of maximally 10%, in particular maximally 2%, over the entire area of the curable coating(s).

In the present apparatus, the radiation dose used for irradiating the radiation-curable coatings, which coatings have been applied to a substrate, is controlled by a shutter element, which shutter element is positioned between the substrate and the radiation unit, and which comprises at least one plate, which plate is movable over some distance in the plane substantially parallel to the substrate for defining the area over which said one or more radiation-curable coatings present on the substrate will be irradiated by the radiation unit. The shutter element is thus disposed in the light path of the light being emitted by the radiation unit in the direction of the substrate on which the coating(s) are present. The shutter element makes it possible to set both the area to be irradiated and the radiation time. Moving the plates preferably takes place in a stepless manner, and thus in fact makes any position between a closed condition (=no radiation) and an open condition (=full radiation) possible. Said movement may take place in a direction parallel to the conveying direction of the substrate or at a certain angle to said conveying direction.

It is in particular preferable if the shutter element comprises two plates which are independently movable towards each other in the plane substantially parallel to the substrate, wherein the position of the plates defines the area over which said one or more radiation-curable coatings present on the substrate will be irradiated by the radiation unit.

In order to further optimise a substantially uniform dose of UV light from the radiation unit, it is preferable if at least one end of the movable plate is provided with a profile. The plates can take up a position such that they touch one another and/or overlap in the closed condition, as a result of which closed condition said one or more radiation-curable coatings present on the substrate will not receive radiation from the radiation sources disposed above the substrate. A sawtooth profile is a preferred profile. In certain embodiments it is preferable, however, if both ends of the movable plates are provided with a sawtooth profile such that a uniform dose of the radiation delivered by the radiation unit is realised, irrespective of the position of the two movable plates in the light path between the radiation sources and said one or more radiation-curable coatings present on the substrate.

The present inventors have therefore found that the shape of the plate of the shutter element advantageously effects the uniformity of the dose of UV light from the radiation source, as a result of which it has thus appeared to be possible to limit the variations in the radiation dose, measured across the width of the substrate, to a value of less than 10%, in particular less than 2%, so that differences in gloss are prevented.

In a special embodiment the shutter element may be connected to a control circuit, in which case the extent and the velocity of the movement of at least one plate of the shutter element is controlled inter-alia by the conveying velocity of the substrate under the radiation sources. In a specific embodiment, it is preferable if at least one plate is movable in a direction substantially parallel to the conveying direction of the substrate, whilst it may also be preferable if said at least one plate is movable in a direction not parallel to the conveying direction of the substrate.

The present invention will be explained in more detail hereinafter by means of a number of examples, in which connection it should be noted, however, that the present invention is by no means limited to such special examples.

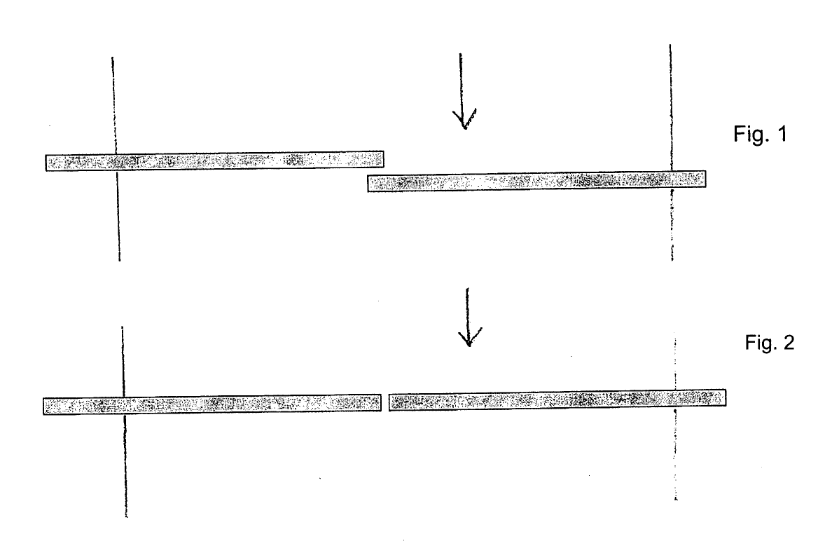

FIG. 1 is a schematic top plan view of two radiation sources.

FIG. 2 is a schematic top plan view of two radiation sources.

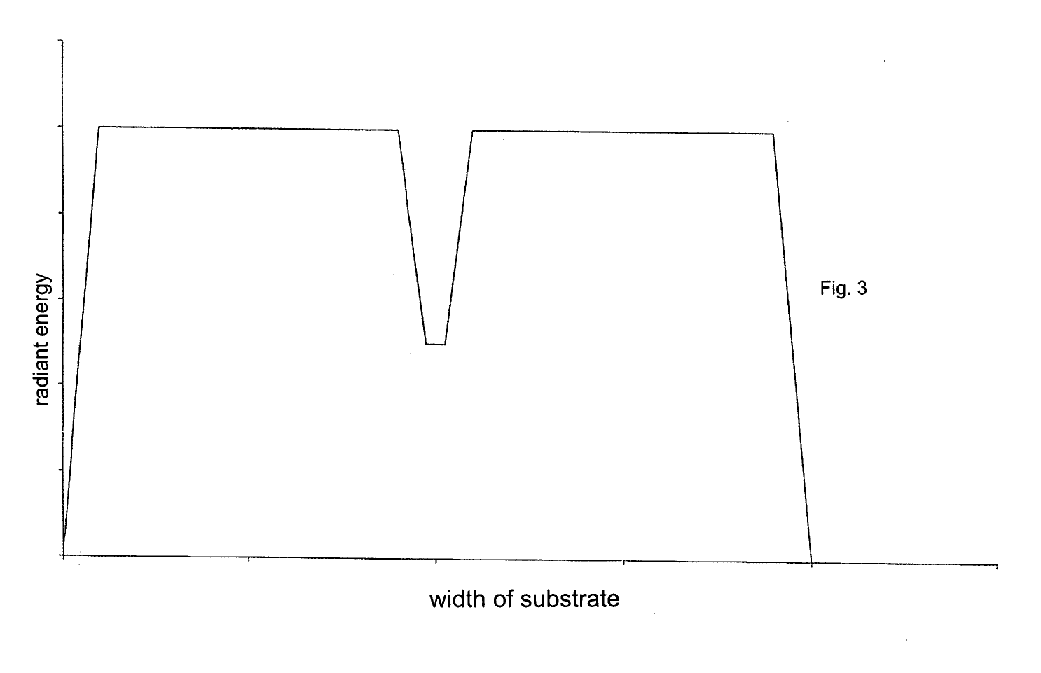

FIG. 3 shows the radiation profile of the radiation source shown in FIG. 2.

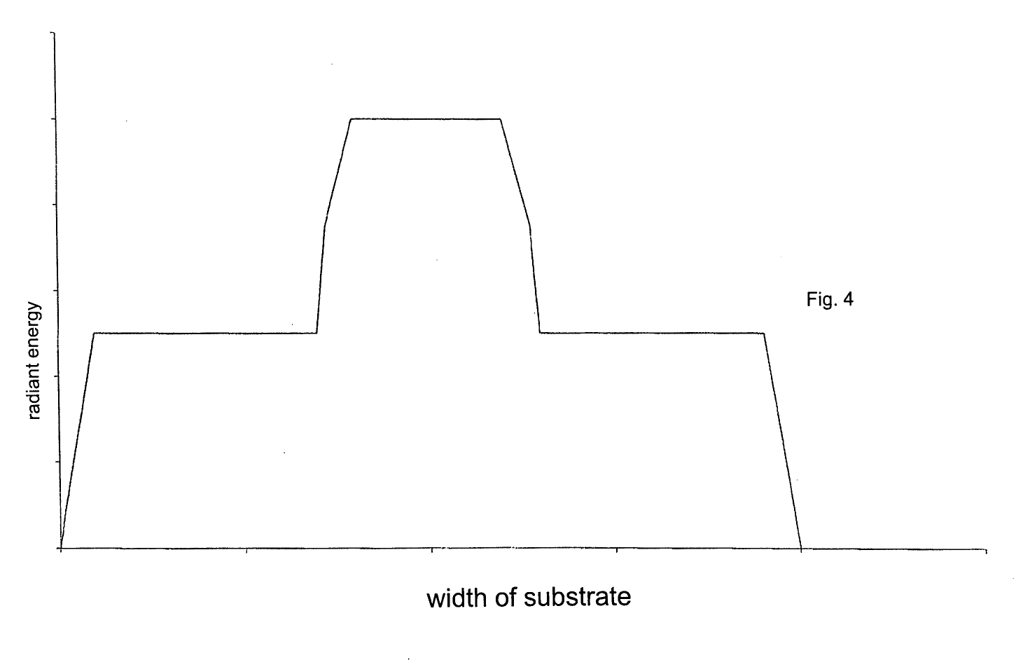

FIG. 4 shows the radiation profile of the radiation sources shown in FIG. 1.

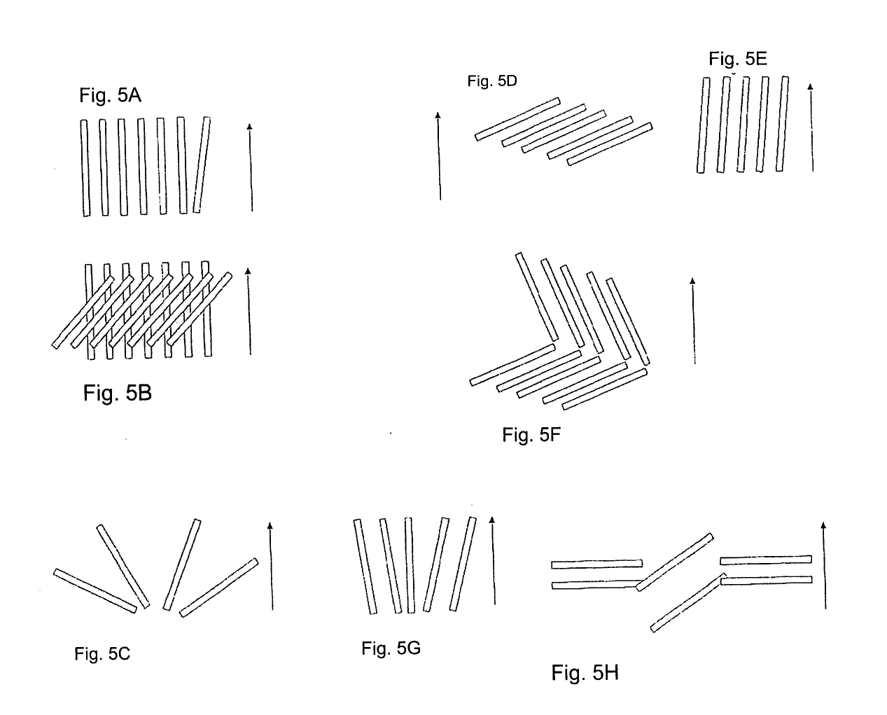

FIGS. 5A-5H show embodiments of radiation sources according to the present invention.

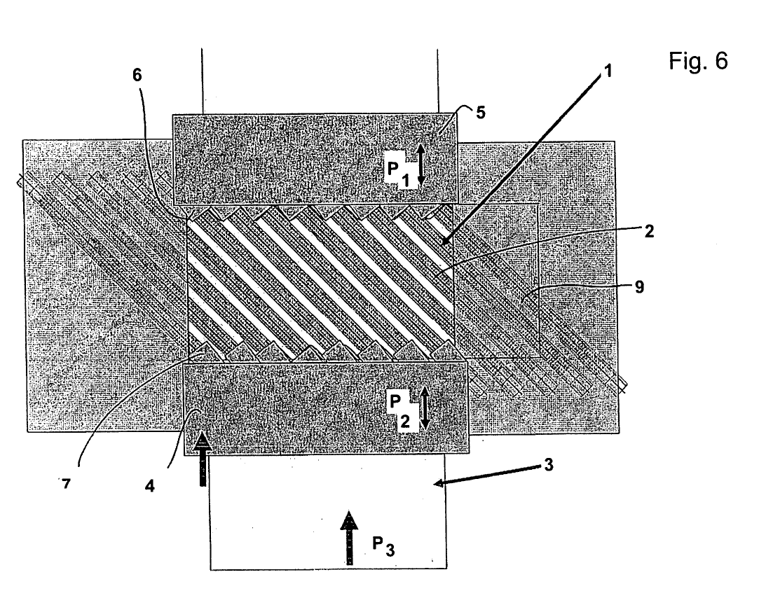

FIG. 6 is a view of the present apparatus.

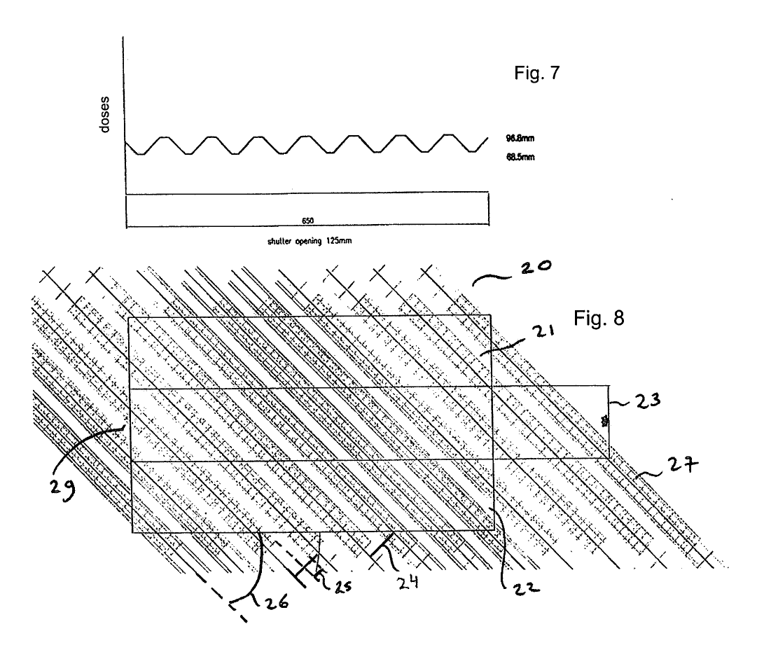

FIG. 7 is a schematic representation of the radiation profile across the width of the substrate.

FIG. 8 is a view of the present invention in relation to FIG. 7.

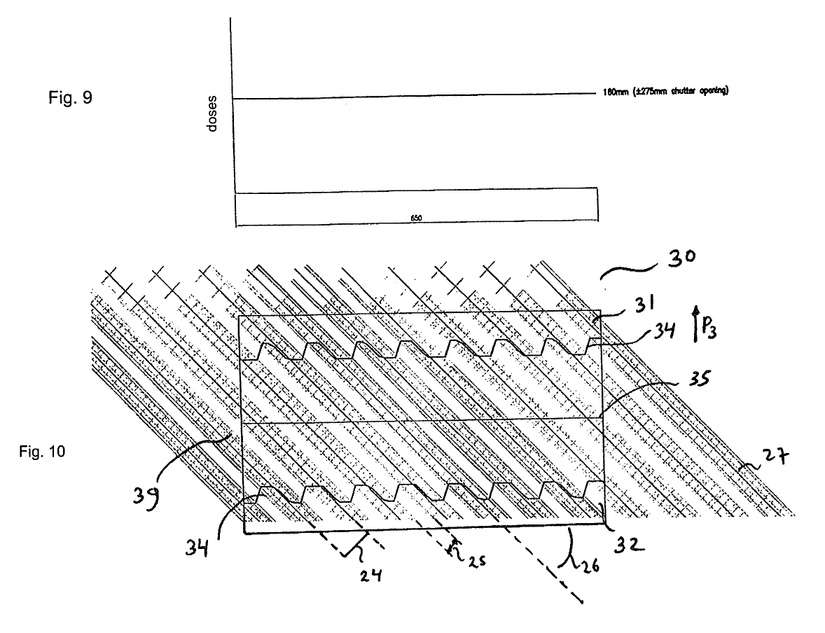

FIG. 9 is a schematic representation of the radiation profile across the width of the substrate.

FIG. 10 is a view of the present invention in relation to FIG. 9.

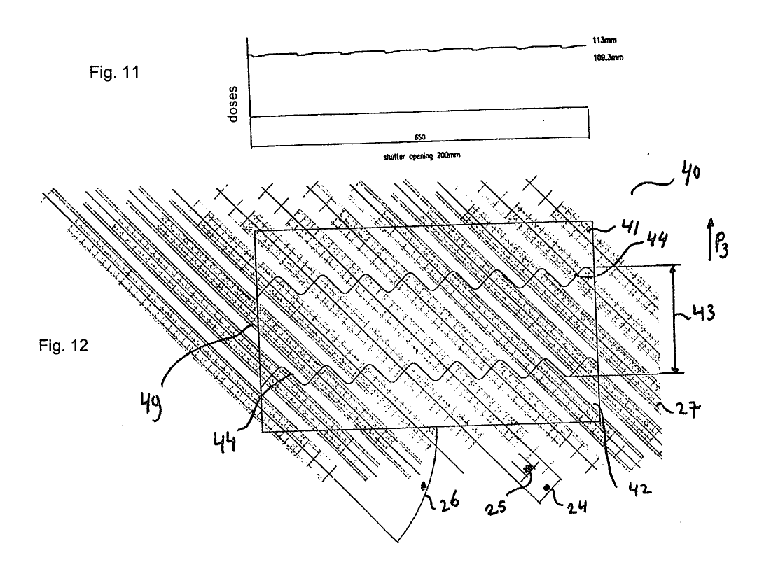

FIG. 11 is a schematic representation of the radiation profile across the width of the substrate.

FIG. 12 is a view of the present invention in relation to FIG. 11.

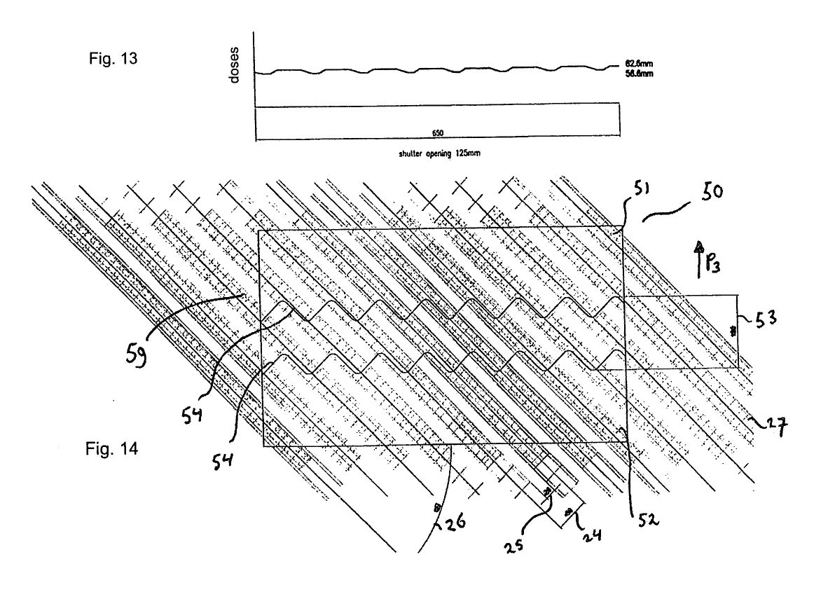

FIG. 13 is a schematic representation of the radiation profile across the width of the substrate.

FIG. 14 is a view of the present invention in relation to FIG. 13.

FIG. 1 schematically shows a top plan view of two radiation sources 1, 2, in which the radiation sources 1, 2 are disposed perpendicularly to the conveying direction (indicated by the arrow) of the substrate (illustrated in full lines). The substrate extends over maximally the length of the radiation sources 1, 2. The radiation sources 1, 2 thus exhibits a certain degree of overlap in the centre of the substrate.

FIG. 2 schematically shows another embodiment of a top plan view of radiation sources 1, 2, in which the radiation sources 1, 2 are disposed perpendicularly to the conveying direction of the substrate (indicated by the arrow), substantially in abutment with each other. The substrate extends over maximally the length of the radiation sources 1, 2. Thus, an area which does not receive direct UV radiation from the radiation sources 1, 2 is present in the centre of the substrate in FIG. 2, whilst in FIG. 1 there is a certain degree of overlap of the radiation sources 1, 2 in the centre of the substrate.

FIG. 3 is a schematic view of the radiation profile of the arrangement shown in FIG. 2, in which the received radiation energy is shown on the vertical axis and the width of the substrate is shown on the horizontal axis. In the centre of the substrate, a decrease of the radiation energy received by the coating(s) present on the substrate can be clearly distinguished, which will lead to undesirable formation of stripes.

FIG. 4 is a schematic view of the radiation profile of the arrangement shown in FIG. 1, in which the received radiation energy is shown on the vertical axis and the width of the substrate is shown on the horizontal axis. In the centre of the substrate, an increased dose in comparison with the remaining area of the substrate can be clearly distinguished. As a result of the non-uniform radiation dose across the width of the substrate shown in FIGS. 3 and 4, a UV curable coating thus matted will exhibit a difference in gloss across the width of the substrate, which is undesirable. Since the substrate is passed under UV radiation sources, the difference in gloss will be perceived as a stripe parallel to the length and thus to the conveying direction of the substrate.

FIGS. 5A-5H schematically show special embodiments of the present apparatus in top plan view, analogous to FIGS. 1 and 2, in which the conveying direction of the substrate (not shown) is indicated by means of an arrow. The aforesaid embodiments are characterised in that at least one of the radiation sources, which radiation sources are positioned above the substrate, is disposed at an angle of 0-90° relative to the conveying direction of the substrate. As is schematically shown in FIG. 5b, for example, the radiation sources may be arranged in layers, which means that the radiation sources may overlap, seen in vertical direction. The substrate extends maximally along the length of the radiation sources.

The present invention in particular concerns the realisation of a uniform UV dose across the width of the substrate.

FIG. 6 schematically shows a top plan view of the present apparatus 10, comprising a substrate 3 which is passed under a number of radiation sources 1, 2 in the direction indicated by the arrow P1, which radiation sources 1, 2 are arranged parallel to each other and which include an angle of 60 degrees with the substrate 3. FIG. 6 clearly shows that the area over which the radiation sources 1, 2 emit UV radiation is larger than the width of the substrate 3. After all, the radiation sources 1, 2 extend beyond the width of the substrate 3. Positioned between the radiation sources 1, 2 and the substrate 3 is a shutter element 9, which comprises two flat plates 4, 5, which flat plates 4, 5 are movable in a plane substantially parallel to the substrate 3, plate 5 being movable in the direction indicated by the arrow P3 and plate 4 being movable in the direction indicated by the arrow P2. Plate 5 and plate 4 can be moved towards each other in such a manner that the radiation sources 1, 2 are screened by the plates, such that the light emitted by the radiation sources 1, 2 cannot reach the substrate 3 positioned thereunder. Plate 5 and plate 4 can be moved independently of each other. Plate 4 and plate 5 are preferably provided with a profile 7 and a profile 6, respectively, at one end, in particular a sawtooth profile. In a special embodiment, the velocity at which and the distance over which the plates 4, 5 are moved can be controlled on the basis of the velocity at which the substrate 3 is passed under the radiation sources 1, 2. Although it is indicated in FIG. 6 that the plates 4, 5 are movable parallel to the conveying direction of the substrate 3, the plates 4, 5 may also be moved at an angle to the substrate 3, as a result of which the movement of the plates 4 and 5 will take place at an angle relative to the conveying direction of the substrate 3.

FIG. 7 schematically shows the profile of the radiation received by a substrate, on which one or more radiation-curable coatings are present, upon exposure of the substrate to UV radiation by the apparatus 20 shown in FIG. 8. In FIG. 7 the width of the substrate is shown on the horizontal axis, and the radiation dose (AU) is shown on the y-axis. FIG. 7 shows that the radiation dose exhibits little fluctuation across the width of the substrate.

The apparatus 20 shown in FIG. 8 for UV irradiation of one or more radiation-curable coatings, which coatings have been applied to the substrate (not shown), comprises a number of radiation sources 27, which are schematically shown in a parallel configuration, whilst the shutter element 29 is positioned in the light path between the radiation sources 27 and the substrate (not shown), which shutter element 29 comprises two plates 21, 22 which are independently movable towards each other in the plane substantially parallel to the substrate, wherein the position of the plates 21, 22 defines the area over which said one or more radiation-curable coatings present on the substrate will be irradiated by the radiation sources 27. The radiation sources 27 are arranged parallel to each other, with a gap 25 present between them, whilst the centre-to-centre distance between the plates is indicated at 24. The movable plates 21, 22 are positioned a mutual distance (indicated at 23) apart, so that only the area formed by the interspace 23 between the plates 21, 22 on the substrate (not shown) can be exposed to UV radiation. The substrate (not shown) is moved in the direction indicated by the arrow P3, whilst the plates 21, 22 are movable in the direction parallel to P3. In a special embodiment it is also possible, however, to move the plates 21, 22 in a direction not parallel to the conveying direction of the substrate.

FIG. 9 is a schematic view of the radiation profile, in which the width of the substrate corresponds to the horizontal axis. FIG. 9 clearly shows that the substrate has received a substantially uniform dose of UV light from the radiation sources across its width, for which purpose the apparatus 30 shown in FIG. 10 was used.

FIG. 10 schematically shows the apparatus 30 for UV irradiation of one or more radiation-curable coatings, which coatings have been applied to a substrate (not shown), which apparatus 30 comprises a shutter element 39, which shutter element 39 comprises two plates 31, 32 which are independently movable towards each other in the plane substantially parallel to the substrate, wherein the position of the plates 31, 32 defines the area over which the coatings will be irradiated by the radiation sources 27. In FIG. 10, the plates 31, 32 are provided with a sawtooth profile at the ends 34 thereof that move towards each other. The substrate (not shown) is moved in the direction indicated by the arrow P3, whilst the plates 31, 32 are movable in the direction parallel to P3. The geometric configuration of the sawtooth profile 34 has been selected so that, depending on the position of the lamps 27, the angle 26 that the lamps 27 make with the shutter element 39, in particular the conveying direction of the substrate, as well as the gap 25 between the lamps 27 and the centre-two-centre distance 24, that a uniform dose of UV light across the width of the substrate, as shown in FIG. 9, is obtained. Numeral 35 indicates the centre of the shutter element 39. The position of the substrate is as shown in FIG. 10.

FIG. 11 schematically shows the radiation profile as a function of the width of the substrate, shown on the horizontal axis, in which a substantially uniform dose of UV light has been effected, using an apparatus 40 for UV irradiation of one or more radiation-curable coatings, which coatings have been applied to a substrate (not shown).

The apparatus 40 is schematically shown in FIG. 12, in which a shutter element 49 is used, which shutter element 49 comprises two plates 41, 42 which are independently movable towards each other in the plane substantially parallel to the substrate, wherein the position of the plates 41, 42 defines the area over which the coatings will be irradiated by the radiation source 27. The two ends 44 of the movable plates 41, 42 are provided with a sawtooth profile, said plates being spaced apart by a distance indicated at 43. The substrate (not shown) is transported in the direction indicated by the arrow P3, whilst the plates 41, 42 are movable in the direction parallel to P3. In this way an area is obtained that will result in a substantially uniform dose of UV light, as shown in FIG. 11.

FIG. 13 is a schematic view of the radiation profile, with the width of the substrate being shown on the horizontal axis, which has been obtained by using an apparatus 50 as schematically shown in FIG. 14 for UV irradiation of one or more radiation-curable coatings, which coatings have been applied to a substrate (not shown).

The apparatus 50 shown in FIG. 14 comprises a shutter element 59, which shutter element 59 comprises two plates 51, 52 which are independently movable towards each other in the plane substantially parallel to the substrate, wherein the position of the plates 51, 52 defines the area over which said one or more radiation-curable coatings present on the substrate will be irradiated by the radiation source 27. The two plates 51, 52 are provided with a sawtooth profile 54 at their respective ends, which plates are spaced apart by a specific distance, indicated at 53, resulting in a radiation profile which is substantially uniform, as is schematically shown in FIG. 13. The substrate (not shown) is conveyed in the direction indicated by the arrow P3, whilst the plates 51, 52 are movable in the direction parallel to P3.

Although mention has consistently been made of movable plates with reference to FIGS. 8, 10, 12 and 14, it should be understood that embodiments in which only one plate is movable are also possible. In addition to that it has been indicated in each of the FIGS. 10, 12 and 14 that both ends of the movable plates are provided with a sawtooth profile, in which connection it should be noted, however, that the present invention is not specifically limited to a sawtooth profile, but that the profile must be selected so that a substantially uniform dose of UV light on the substrate is effected, wherein in a specific embodiment only one of the plates is provided with a profile, for example a sawtooth profile.

In FIGS. 8, 10, 12 and 14, the shutter element in question may be connected to the control circuit, and the movement of said at least one plate is controlled on the basis of the conveying velocity of the substrate under the radiation source. The velocity of the substrate under the radiation source may furthermore be used for dimming the radiation source itself. In addition to that, embodiments are possible in which the direction of movement of the movable plates is not parallel to the conveying direction of the substrate.

1. An apparatus for UV irradiation of one or more radiation-curable coatings, which one or more radiation-curable coatings have been applied to a substrate, which apparatus comprises a radiation unit for irradiating said one or more radiation-curable coatings present on the substrate, which radiation unit comprises one or more radiation sources, which substrate is passed under the radiation unit in a conveying direction, characterised in that wherein the apparatus further comprises a shutter element, which shutter element is positioned between the substrate and the radiation unit, and which shutter element comprises at least one plate, said at least one plate having at least one end, which plate is movable over some distance in the plane substantially parallel to the substrate for defining than area over which said one or more radiation-curable coatings present on the substrate will be irradiated by the radiation unit.

2. The apparatus according to claim 1, wherein the shutter element comprises two plates which are independently movable towards each other in the plane substantially parallel to the substrate, wherein the position of the plates defines the area over which said one or more radiation-curable coatings present on the substrate will be irradiated by the radiation unit.

3. The apparatus according to claim 1 wherein at least one end of the at least one movable plate is provided with a profile.

4. The apparatus according to claim 1 wherein said at least one plate can take up a position such that two ends thereof touch one another and/or overlap, as a result of which said one or more radiation-curable coatings present on the substrate will not receive radiation from the radiation unit disposed above the substrate.

5. The apparatus according to claim 3 wherein said profile comprises a sawtooth profile.

6. The apparatus according to claim 1 wherein the shutter element is connected to a control circuit, wherein the movement of said at least one plate is controlled by a conveying velocity of the substrate under the radiation unit.

7. The apparatus according to claim 6, wherein the conveying velocity of the substrate under the radiation unit controls dimming of the radiation unit.

8. The apparatus according to claim 1 wherein said at least one plate is movable in a direction substantially parallel to the conveying direction of the substrate.

9. The apparatus according to claim 1 wherein said at least one plate is movable in a direction not parallel to the conveying direction of the substrate.

10. The apparatus according to claim 1 wherein two ends of the at least one plate are provided with a sawtooth profile, such that a uniform dose of the radiation delivered by the radiation unit is realized, irrespective of the position of the at least one plate in a light path between the at least one plate and said one or more radiation-curable coatings present on the substrate.

11. The apparatus according to claim 1 wherein the radiation unit comprises at least two separated radiation sources, which are each disposed in such a manner relative to the conveying direction of the substrate that said one or more radiation-curable coatings present on the substrate will be exposed to a substantially uniform dose of UV light from the radiation sources across a width of the substrate.

12. The apparatus according to claim 1 wherein the spacing between said one or more radiation sources and the substrate provided with one or more radiation-curable coatings, which is positioned thereunder, is 10-100 mm.

13. The apparatus according to claim 12, wherein said spacing is 20-40 mm.

14. The apparatus according to claim 1 wherein two or more radiation sources are present and said two or more radiation sources emit radiation in the wavelength range of 100-450 nm.

15. The apparatus according to claim 14, wherein said two or more radiation sources emit radiation in the wavelength range of 100-250 nm.

16. The apparatus according to claim 15, wherein said two or more radiation sources emit radiation in the wavelength range of 170-180 nm.

17. The apparatus according to claim 16, wherein said two or more radiation sources emit monochromatic radiation having a wavelength of 172 nm.

18. The apparatus according to claim 14, wherein said two or more radiation sources emit monochromatic radiation having a wavelength of 222 nm.

19. The apparatus according to claim 1 wherein the radiation-curable coatings are irradiated with a total radiation dose between 1-3000 mJ/m².

20. The apparatus according to claim 19, wherein the radiation-curable coatings are irradiated with a total radiation dose between 1-30 mJ/m².

21. The apparatus according to claim 19 wherein the radiation-curable coatings are irradiated with a total radiation dose between 3-12 mJ/m².

22. The apparatus according to claim 11 wherein at least one of said one or more radiation sources is disposed at an angle of 0-90 degrees relative to the conveying direction of the substrate.

23. The apparatus according to claim 22, wherein at least one of said one or more radiation sources is disposed at an angle of 20-70 degrees relative to the conveying direction of the substrate.

24. The apparatus according to claim 11 wherein said at least two separated radiation sources are positioned parallel to each other.

25. The apparatus according to claim 11 wherein a length of the radiation sources is less than the width of the substrate.

26. A method for UV irradiation of one or more radiation-curable coatings, which one or more radiation-curable coatings have been applied to a substrate, wherein a radiation unit for irradiating said one or more radiation-curable coatings present on the substrate is disposed above the substrate, which radiation unit comprises one or more radiation sources, wherein a shutter element is positioned between the substrate and the radiation unit, which shutter element comprises at least one plate, which at least one plate is movable over some distance in a plane substantially parallel to the substrate, wherein the position of the plate defines an area over which the radiation unit emits UV radiation.

27. The method according to claim 26, wherein the shutter element comprises two plates which are independently movable towards each other in the plane substantially parallel to the substrate, which plates are moved towards each other so as to define the area over which said one or more radiation-curable coatings present on the substrate will be irradiated by the radiation unit.

28. The method according to claim 26 wherein the shutter element is connected to a control circuit, wherein movement of said at least one plate element is controlled inter alia by a conveying velocity of the substrate under the radiation unit.

29. The method according to claim 26 wherein the conveying velocity of the substrate under the radiation unit controls dimming of the radiation unit.

30. The method according to claim 26 wherein said at least one plate is movable in a direction substantially parallel to the conveying direction of the substrate.

31. The method according to claim 26 wherein a radiation unit comprises at least two separated radiation sources, which are each disposed in such a manner relative to the conveying direction of the substrate that said one or more radiation-curable coatings present on the substrate will be exposed to a substantially uniform dose of UV light from the radiation sources across a width of the substrate.

32. The method according to claim 26 wherein one or more radiation-curable coatings are irradiated for a period of 50-800 ms.

33. The method according to claim 26 wherein the substrate is passed under the radiation unit at a velocity of 40-400 m/minute.

34. The method according to claim 26 wherein the radiation-curable coatings are irradiated with a radiation dose of from 1-3000 mJ/m².

35. The method according to claim 26 wherein the radiation unit emits light in the wavelength range of 100-250 nm.

36. A substrate provided with one or more radiation-curable coatings, wherein a radiation dose received by the one or more radiation-curable coatings exhibits a variation of maximally 10% over the entire area of the one or more radiation-curable coatings.
